(19) United States
(12) Patent Application Publication
(10) Pub. No.: US 2024/0103291 A1
(43) Pub. Date: Mar. 28, 2024

(54) METHOD FOR PRODUCING A COMPONENT FOR A MEDICAL IMAGING DEVICE

(71) Applicant: Siemens Healthcare GmbH, Erlangen (DE)

(72) Inventor: Jan Wrege, Erlangen (DE)

(21) Appl. No.: 18/372,091

(22) Filed: Sep. 23, 2023

(30) Foreign Application Priority Data
Sep. 23, 2022 (DE) 10 2022 210 085.9

(51) Int. Cl. G02B 27/30; B32B 7/12; G21K 1/02

(52) U.S. Cl. CPC G02B 27/30; B32B 7/12; G21K 1/02; B32B 2535/00; B32B 2551/00

(57) ABSTRACT

A method for producing a component for a medical imaging device is provided. A first substrate layer and a second substrate layer are stacked and connected to one another via a material bonding layer. The material bonding layer is hardened for this purpose. A hardening is provided in an at least two-stage hardening process that includes a first hardening act and a second hardening act. The first hardening act serves to pre-fix the first substrate layer and the second substrate layer to one another.

This application claims the benefit of German Patent Application No. DE 10 2022 210 085.9, filed on Sep. 23, 2022, which is hereby incorporated by reference in its entirety.

### BACKGROUND

The present embodiments relate to a method for producing a component for a medical imaging device.

Components for medical imaging devices are widely known from the prior art. For example, the prior art knows about components for medical imaging devices that are suitable for and are configured for radiation guidance in the medical imaging device. The radiation guidance components may be intended to guide x-ray radiation. For example, collimators are used in order to select x-ray radiation at a scintillator or another detector. Such components (e.g., such collimators) are characterized by a very specific microstructure, which is expensive to produce. For example, a microstructuring is necessary that has a comparatively high aspect ratio. In such cases, the structurings form an arrangement of channels, for example.

As an example of the prior art, the teaching of U.S. Pat. No. 9,996,158 B2 relate to a method for production of a collimator.

An aspect ratio is understood as the ratio of a length or depth to be determined in the longitudinal direction or direction of extension to a lateral extent of the structuring. In the case of a collimator, the longitudinal direction for the microstructuring is predetermined by the direction in which the radiation propagates through the component. The lateral extent is then measured at right angles thereto. The required aspect ratios for such microstructurings are not able to be realized in such cases simply by removing or separating a corresponding cutout from a block-shaped body. Instead, the established practice is to stack a number of layers (e.g., a number of substrate layers with corresponding cutouts) above one another such that at least partly overlapping cutouts in the stack of the first substrate layer and the second substrate layer join together such that the first substrate layer and the second substrate layer form a structuring (e.g., an inner structuring in the form of a channel). This allows the desired aspect ratios to be realized (e.g., by the stacking of any given number of substrate layers).

With increasing interest in ever finer structures, the demands relating to the stacking process naturally also increase. A corresponding offset between the individual layers may lead to an adverse effect on the desired dimensioning or form of the structuring. For example, it has likewise also proved to be a challenge to maintain the arrangement of the layers stacked on top of one another during a hardening process. During such a hardening process, a means of material bonding (e.g., an adhesive) is hardened in order to make a bond between the first substrate layer and a second substrate layer. The means of material bonding is arranged for this purpose between the substrate layers to be bonded.

For this reason, measures have been developed with which the stacking and, for example, also the maintenance of the arrangement of the individual substrate layers in the stack is simplified. In such cases, it often turns out to be a challenge to automate the method acts required for the method in order, for example, to be able to integrate the method acts reliably into a series production system.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method for production of components for medical imaging devices is improved (e.g., with respect to process security, efficiency, and wear on materials of the tools used).

In accordance with a first aspect, a method for producing a component for a medical imaging device (e.g., for a radiation guidance component for a medical imaging device) is provided. The method includes providing a first substrate layer and a second substrate layer, and stacking of the first substrate layer and the second substrate layer, where a material bonding layer that includes a material bonding is arranged between the first substrate layer and the second substrate layer. The method includes material-to-material bonding of the first substrate layer with the second substrate layer by hardening and providing the component, which includes the first substrate layer and the second substrate layer, which are bonded to one another by material-to-material bonding. The hardening includes a first hardening act and a second hardening act, where a first part area of the material bonding layer is hardened in the first hardening act, and a second part area of the material-bonded layer is hardened in the second hardening act.

By contrast with the procedure known from the prior art, the method of the present embodiments makes provision for an at least two-stage hardening process or two-stage hardening to be provided, which includes both a first hardening act and also a second hardening act. In this case, a first part area of the material bonding layer is explicitly hardened with the first hardening act. The partial hardening in the first hardening act may make it possible already to fix the relative substrate layer or position of the first substrate layer in relation to the second substrate layer before a conclusion of the hardening. In this way, a displacement between the first substrate layer and the second substrate layer, which may have a negative effect on the dimensioning or form of an intended micro structuring, for example, is prevented from occurring in the further hardening process. In this case, at least for the second hardening act, no additional means are necessary for fixing the first substrate layer in relation to the second substrate layer.

In the second hardening act, a second part area of the material bonding layer is hardened in order, for example, to end the hardening process of the material bonding layer. In other words, the second hardening act finalizes the overall hardening process or the overall hardening, and the second part area corresponds, for example, to those part areas of the material bonding layer that do not conclusively harden or have not been conclusively hardened in the first hardening act. For example, the second part area of the material bonding layer involves a complementary part of the first part area in the material bonding layer. In this case, the full surface of the material bonding layer may be arranged between the first substrate layer and the second substrate layer.

Thus, an at least two-stage process is provided, which provides a pre-fixing by the first hardening act and the complete hardening of the material bonding layer in order to provide the desired bonding layer.

It has been shown in this case, for example, that by the first hardening act and the pre-fixing caused by this between the first substrate layer and the second substrate layer, the automation processes during bonding of the substrate layers in the stack may be simplified.

For example, there is provision in this case for the first part area to be smaller than the second part area (e.g., with respect to its total surface extent, such as at least 10 times smaller, 15 times smaller, or 20 times smaller than the second part area). In this case, the first part area may be selected as an edge area or part section of an edge area of the material bonding layer. The first part area may then be arranged in a plane on the outer edge area of the first substrate layer and/or the second substrate layer lying parallel to the main extension plane of the first substrate layer and the second substrate layer.

In this case, that area that is embodied on the outer circumference of a substrate layer extending along the main extension plane may be understood as the edge area of the first stack layer and/or of the second stack layer. In this case, the edge may extend from an outermost circumference of the first substrate layer and/or second substrate layer far enough, for example, in the direction of a center of the first substrate layer and/or the second substrate layer, for a ratio of a surrounding planar edge area to an overall surface of the upper side of the first substrate layer and/or the second substrate layer to be smaller than 10%, smaller than 5%, or smaller than 2.5%. In this case, the planar extent is measured in parallel to the main extension plane of the substrate layers.

For a ratio that is smaller than 5%, the first part areas are defined in an area that is arranged on the outermost edge (e.g., of the stack). If in the method at a later point in time these sections are removed in their turn, it proves advantageous to remove these areas that lie as far as possible from the edge in order to lose as little material as possible during the cutting up/cropping process. Likewise, access to the edge areas lying on the outside for a hardening means with which the first hardening act is carried out is comparatively simple. This applies, for example, to a stack of more than three substrate layers. The first part area may, for example, extend over an entire edge side, or only include part areas of a corresponding edge area. The first part area may also be realized with an unbroken circumference in the edge area. In one embodiment, the first part area may be formed by points or linear sections, interrupted or uninterrupted. For example, first part areas may be formed by a number of points and/or linear sections, or points or linear sections that are only arranged in corners or the respective substrate layer.

The first hardening act and the second hardening act may be carried out overlapping temporally and/or spatially. In other words, the second hardening act may begin before the first hardening act has ended. In one embodiment, the second hardening may only be started when the first hardening act has ended.

Further, a pre-fixing by the first hardening act, since in this way corresponding holding apparatuses or stabilizing apparatuses, with which the alignment of the individual layers in the stack made up of first substrate layers and/or second substrate layers is provided, may be removed for the second hardening act. This proves to be advantageous when the holding apparatus otherwise has to be introduced into another apparatus for carrying out the second preliminary act. This provides that the corresponding tool used as holding element or holding apparatus is less adversely affected (e.g., by the corresponding hardening means that is employed for the second hardening act). This proves to be advantageous for the service life of the apparatus or tool with which the method is carried out.

The first substrate layer and/or the second substrate layer may form essentially flat components that extend along a main extension plane. These may be produced, for example, in a casting method and/or by a punching or stamping process. In one embodiment, the first substrate layer and/or the second substrate layer involve microfine cast parts and/or contour etched parts and/or films with etched-in structuring.

Materials for the first substrate layer and/or second substrate layer may be provided, which, for example, are suitable for production in a microfine casting method. Materials that are amenable to lithographic etching may also be involved, however, and/or materials are involved that are capable of being cast in order to produce cast first substrate layers or second substrate layers. The first substrate layers and/or second substrate layers may be provided as lithographically etched film. In one embodiment, the first substrate layer and/or the second substrate layer may be layered as a component (e.g., as a fine-cast component) and provided to the method. For example, the first substrate layer and/or the second substrate layer involves such a component that includes silicon or tungsten.

In one embodiment, the first substrate layer and the second substrate layer have a thickness that has a value of between 0.5 mm and 10 mm, between 1 mm and 5 mm, or between 2 mm and 3 mm. In this case, a thickness of the first substrate layer may differ from a thickness of the second substrate layer. As an alternative, the thickness of the first substrate layer and the thickness of the second substrate layer may essentially correspond with one another.

While the description focuses on the first substrate layer and the second substrate layer, the component may also be made up of a number of substrate layers that are joined together. In order to provide a component for a medical imaging device, there may be provision for at least 3, at least 5, or at least 10 substrate layers to be arranged above one another in order to be connected to one another. In this case, the first substrate layer and the second substrate layer are part of the plurality of substrate layers and may, for example, be cover layers and/or layers within the stack.

In accordance with a form of embodiment, there is provision for the first substrate layer to have a first cutout and the second substrate layer to have a second cutout. The first substrate layer and the second substrate layer are stacked such that the first cutout and the second cutout in a stack direction are arranged at least in sections overlapping above one another. This makes it possible, through the cutouts stacked above one another (e.g., the first cutout and the second cutout), to provide a structuring within the formed component. For example, it is possible in this way to realize corresponding aspect ratios that have proved to be advantageous for the components in medical imaging devices. In this case, the first cutout and/or second cutout mostly has a cross-section running at right angles to the radiation direction or stack direction, which, for example, is rectangular, square, or polygonal. In one embodiment, however, the cross-section may be round or elliptical.

In one embodiment, there is provision, when the first substrate layer differs from the second substrate layer and in the case of a stack made up of a plurality of substrate layers, for all substrate layers that are stacked to differ from one another (e.g., with respect to their size and/or with respect to a shape of the cutouts that are let into the first substrate layer and/or the second substrate layer). For example, the first cutout in a cross-section running in parallel to the main extension plane may be smaller than the second cutout. This makes it possible to bring about a desired taper in the structuring (e.g., in the form of a tapering channel).

In one embodiment, there is provision for the stacking of a number of layers with corresponding cutouts to lead to the formation of a channel, which may be configured tapering in a stack direction. There is, for example, provision for the first cutout and/or the second cutout each to be embodied tapering. In other words, within the first cutout and/or second cutout, the size of the cross section changes in the stack direction. This avoids a stepped course being configured between the individual cutouts. Instead, an essentially conically tapering microchannel is produced, which may extend continuously from a front side through to a rear side lying opposite the front side of the component.

In one embodiment, there is provision for a number of first cutouts and a number of second cutouts, respectively, in the first substrate layer and the second substrate layer to be arranged in the form of a grid. This produces a grid-shaped arrangement of channels (e.g., microchannels) that extend from a front side to a rear side of the component and are thus suitable for guidance of x-ray radiation (e.g., in the form of a collimator). For example, the channels formed are arranged in the manner of a chess board.

In one embodiment, there is provision, by the arrangement of the first cutout and the second cutout, for a micro structuring to be realized. There is, for example, provision for the first cutout and/or second cutout, along their maximum cutout, to have a width that is less than 120 μm, less than 110 μm, or less than 100 μm.

In one embodiment, there is provision for the structuring (e.g., the micro structuring) in the component to have an aspect ratio that is greater than 2, greater than 10, or greater than 20. The method is accordingly employed to design structurings that are as fine as possible (e.g., micro structurings that may have decidedly high aspect ratios).

In one embodiment, there is provision for the first hardening act to be concluded after a first time interval and the second hardening step to be concluded after a second time interval. The second time interval is greater than the first time interval. In one embodiment, there is provision for the second time interval to be more than 5 times, more than 10 times, or more than 15 times greater than the first time interval. This makes it possible, in a comparatively rapid first hardening act, to implement the pre-fixing, in order to realize the final hardening in a stress-reduced process in which the second hardening act is carried out. The rapid or the comparatively rapid pre-fixing in the first hardening act provides, as quickly as possible, that a slippage of the first substrate layer in relation to the second substrate layer is prevented or stopped.

In one embodiment, there is provision for the first hardening act to be brought about by a first hardening, and the second hardening act to be brought about by a second hardening. The first hardening may differ from the second hardening. In one embodiment, the first hardening only acts on the first part area. For example, there is provision for a chemically-acting hardening and/or an optically-acting hardening (e.g., light, such as UV light or infrared light) to be provided or used as the first hardening, with which a corresponding first hardening act is brought about or carried out. For example, the use of laser light allows the first part area to be defined as accurately and precisely as possible, and this dispenses with a long-lasting adverse environment, such as, for example, a wet chemical environment that otherwise may also damage the holding element over the long term. Further, it is possible, with a corresponding adaptation of the intensity used, to speed up the hardening process such that the first hardening act is concluded after the shortest time. The second hardening may use a thermal energy. For example, the second hardening involves an oven or a conveyor oven, with which the second part area of the material bonding layer is hardened in the second hardening act.

In one embodiment, there is provision for a holding apparatus to be used in order to simplify the stacking and/or to stabilize the arrangement of the first substrate layer and the second substrate layer, at least during the first hardening act. For example, a supporting frame may be provided as holding apparatus.

The holding apparatus in this case may be in a single part or in a number of parts. For example, there may be provision for the holding apparatus to be configured such that the holding apparatus allows access to the first part area for carrying out the first hardening act. For example, the holding apparatus is configured such that edge areas of arrangement, composed of the first substrate layer and the second substrate layer, are freely accessible for processing by the first hardening. For example, corresponding free areas are provided in the holding apparatus, which explicitly allow that, in the first part area, the first hardening gets into the first part area. For example, a corresponding frame that has free areas or window areas may be provided to enable the first hardening to act on the first part area of the material bonding layer.

In one embodiment, there is provision for the holding apparatus to be removed at a time before the second hardening act. The removal of the holding apparatus, for example, proves advantageous when the second hardening act (e.g., its second hardening), at least with long-term or repeated action, adversely affects the holding apparatus or even damages the holding apparatus. This enables the service life of the holding apparatus used to be lengthened. Further, the holding apparatus is then ready for a new stacking, and there does not need to be a wait for the second hardening step to end.

Further, when the light employed for hardening in the first hardening process or a first hardening act is directed in such a way onto the edge areas, a beam path may run essentially in parallel or at an angle of less than 45° to the main extension plane of the first substrate layer and/or the second substrate layer.

In one embodiment, there is provision, after the stacking, for the first substrate layer and the second substrate layer to be pressed together. This provides that the first substrate layer and second substrate layer are arranged in relation to one another such that the first substrate layer and the second substrate layer are in contact over their fullest possible surface with the material bonding layer in order to be able to form a homogeneous bonding layer extending over the full surface.

In one embodiment, there is provision for the material bonding layer to include a material bonding that allows hardening with the first hardening and the second hardening. For example, a corresponding material may be used (e.g., a dual-cure material, such as dual-cure resins of epoxy resins) that is basically configured to carry out hardening processes of a different type. In one embodiment, a substance that is available both for a hardening by light (e.g., UV radiation) and also a hardening by warmth or heat may be used.

As an alternative, the material bonding layer may be realized from two different or at least two different means of material bonding. A first means of material bonding is then explicitly introduced into the first part area, and the second means of material bonding is then explicitly introduced into the second part area. Compared to such an approach in which a first material bonding part layer and a second material bonding part layer are provided, the use of one that is available for a first and a second hardening process proves advantageous since only a comparatively simple and non-expensive introduction and arrangement between the first substrate layer and the second substrate layer is to be provided.

For example, there is provision after the stacking for the first substrate layer and the second substrate layer to be pressed together. This allows a homogeneously distributed and a comparatively thin material bonding layer to be provided.

In one embodiment, there is provision for trimming the component with a body that includes the first substrate layer with the materially-bonded second substrate layer after hardening. This provides that edge areas are removed from the body that has been used, for example, to accept and/or to contact shaping elements or other holding elements of the holding apparatus. These sections in the body do not contribute to the function of the later component and may therefore be removed. Through the use of the method with the first hardening act and the second hardening act, it is possible to keep the areas as small as possible, which may be removed in order to provide the final body for the component. Possible holding apparatuses or apertures no longer have to be formed in the first substrate layer and the second substrate layer for a corresponding holding apparatus.

In one embodiment, there is provision for the first substrate layer and/or the second substrate layer to be made of an x-ray-proof material. This proves advantageous, for example, if a component to be produced is used, for example, for radiation guidance in an apparatus that works with x-ray radiation.

For example, a component in a computed tomography device (CT) (e.g., a collimator that is used to collimate x-ray radiation) is involved.

For example, there is also provision for the means of material bonding to be x-ray-proof or to consist of an x-ray-proof material. This enables it to be provided that the bond between the first substrate layer and the second substrate layer is not released because the connection through the means of material bonding releases over time.

Further, there may be provision for the means of material bonding to be suitable for carrying out a stress-reduced hardening, and/or or to provide a sufficient strength of the connection under operating load (e.g., taking into consideration the resistance to x-rays).

In one embodiment, there is provision for the material bonding layer to be applied to the first substrate layer and/or the second substrate layer by a transfer method (e.g., at a point in time before the stacking of the first substrate layer and second substrate layer). To this end, there is provision, first of all, for a film to be applied (e.g., by spreading, spraying, and/or stamping), and for this applied film to be applied within the framework of a transfer mechanism to the first substrate layer and/or the second substrate layer (e.g., on its upper and/or lower side).

Further, there may be provision, as well as its production, also for the integration into a medical imaging device. There is provision, after the production of the component (e.g., production in accordance with the present embodiments), for the component also to be integrated into the medical imaging device. For example, there is provision for the component to be built into the imaging device such that the component is suitable for radiation guidance. For example, a collimator is involved that focuses or collimates x-ray radiation on a detector (e.g., a scintillation detector).

Further advantages and features emerge from the description of forms of embodiment of the subject matter given below, which refer to the enclosed figures. Individual features of the individual forms of embodiment may be combined with one another within the framework of the present embodiments in such cases.

### BRIEF DESCRIPTION OF THE DRAWINGS

FIG. 1 shows a schematic of an arrangement consisting of a stack layer and a second stack layer for a method in accordance with a first embodiment; and

FIG. 2 shows a schematic of a method in accordance with a second embodiment.

### DETAILED DESCRIPTION

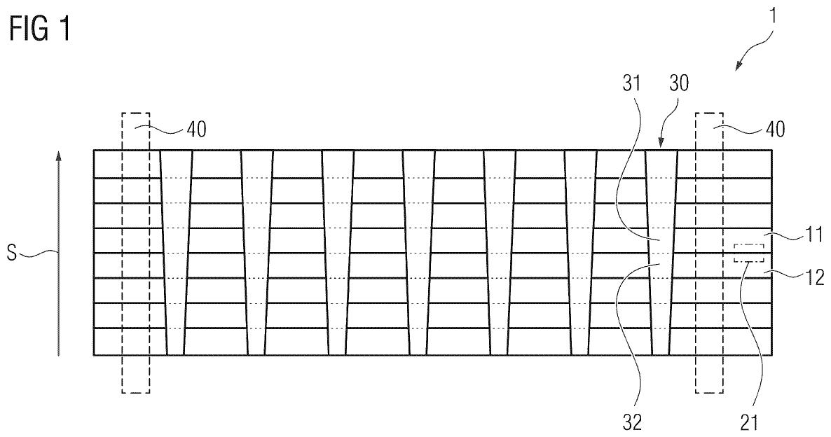

Shown in FIG. 1, by way of an example, is an arrangement made up of a first stack layer 11 and second stack layer 12, from which, by a method in accordance with an embodiment, a component 1 for a medical imaging device is produced. In the description given below, the text focuses on a first substrate layer 11 and a second substrate layer 12. The advantages and features described may, however, be expanded to the formation of an arrangement made up of a plurality of further substrate layers, which together ,au be connected to form a body within the framework of a bonding method. In one embodiment, the component may be formed from at least three substrate layers, at least five substrate layers, or at least ten substrate layers. In one embodiment, the number of substrate layers stacked above one another and connected to one another is greater than 5 and less than 15. The first substrate layer 11 and second substrate layer 12 described in the figures are to be found within a stack made up of a number of substrate layers. However, the first substrate layer 11 and/or the second substrate layer 12 may also involve cover layers for the stack or the component 1.

For example, a component 1 that is provided as a collimator for a CT device is involved. Such a collimator essentially includes a cuboid body, into which a plurality of structurings 30 (e.g., microchannels) is integrated. These microchannels 30 extend from a front side to a rear side (e.g., in one direction), which is predetermined by the beam path or runs in parallel to a stack direction S, along which the first stack layer 11 and the second stack layer 12 are stacked above one another. Thus, there is provision for corresponding radiation to be guided (e.g., x-ray radiation) via the front side through the microchannels 30 to the rear side. The microchannels 30 in this case may be configured such that the microchannels 30 taper from the front side towards the rear side (e.g., run together into a cone). For example, the first substrate layer 11 and/or the second substrate layer 12 is made of tungsten and/or a material or mixture of materials with similar absorption properties.

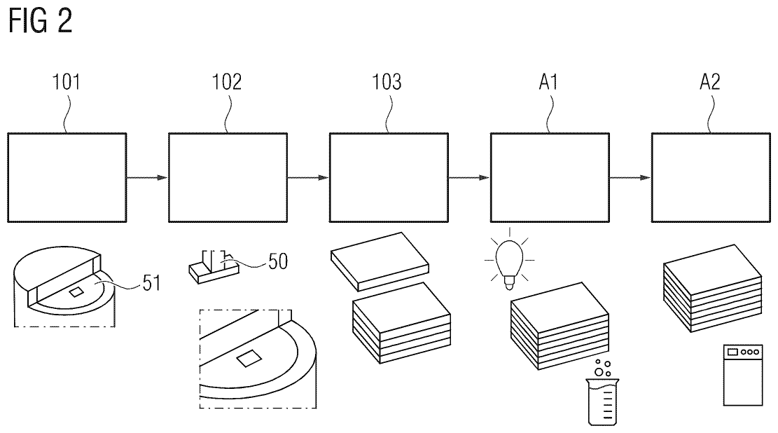

Shown in FIG. 2 is an example of an execution sequence of a method. In a first method act 101, a film is applied. In this case, a corresponding means of material bonding is applied by a spreader, a sprayer, a brush, and/or a stamp to the surface 51. Using a corresponding transfer facility (e.g., a stamp element 50), it is then possible to take the means of material bonding in a second method act 102 from the application surface 51 and apply the means of material bonding to a first substrate layer 11 and/or second substrate layer 12. This may also be undertaken by a print stamping or dip process. This makes it possible to wet an upper and/or lower side of a first substrate layer 11 and/or second substrate layer 12 with a means of material bonding. In a third method act 103, there is provision for the first substrate layer 11 and the second substrate layer 12 to be arranged above one another in a stack direction S and, for example, be pressed against one another.

In one embodiment, the stack direction S runs in a direction running at right angles to the main extension plane. The main extension plane is predetermined by the planar extent of the first substrate layer 11 and/or second substrate layer 12. The stack direction S may be essentially parallel to the direction along which the radiation to be guided passes through the component 1. For example, there is provision for the first substrate layer 11 to have a first cutout 31 and for the second substrate layer 12 to have a second cutout 32. Through the stacking above one another and alignment of the first cutout 31 and the second cutout 32 to one another, a channel is formed by the first cutout 31 and second cutout 32 when the first cutout 31 and the second cutout 32 at least partly overlap in the stack direction S.

For example, the first cutout 31 and/or the second cutout 32 may be comparatively small (e.g., to have a maximum extent in the main extension plane), which is less than 150 μm, less than 125 μm, or less than 100 μm. This allows a microchannel structure to be realized within the component 1. For example, the micro structuring consists of an arrangement of a number of channels running in parallel to one another and, for example, arranged in the shape of a grid relative to one another, which each essentially follow that direction that is predetermined by the stack direction S.

For example, there is provision, in an automatic installation process or arrangement process, for the first substrate layer 11 and/or the second substrate layer 12 to be automatically arranged above one another. For example, a holding apparatus is used during stacking. The holding apparatus may include a supporting frame, for example. For example, the holding apparatus includes forming elements as its holding elements, which are configured to fix the substrate layers in relation to one another.

In a fourth method act and a fifth method act, there is provision for the means of material bonding, which is arranged between the first substrate layer 11 and the second substrate layer, to be hardened. There is provision for a hardening, which includes a first hardening act A1 and a second hardening act A2. The fourth method act is thus formed by the first hardening act A1, and the fifth method act is thus formed by the second hardening act A2.

As already noted, there may be provision, as well as the first substrate layer 11 and second substrate layer 12, for a plurality of further substrate layers to be provided in order to form the component. The bonding process may be carried out, for example, in all layers simultaneously (e.g., the first hardening act and the second hardening act take place simultaneously between all layers).

For example, there is provision for the material bonding means layer to be made of a material that is amenable to hardening, brought about by two different hardening means. For example, there is provision, as the first hardening means, for light (e.g., infrared light or UV light) to be employed and/or a chemical medium. The first hardening act A1 is, for example, configured so that the first hardening act A1 hardens a first part area 21 of the material bonding means layer comparatively rapidly. This makes it possible to use these first already hardened part areas 21 for pre-fixing of the relative substrate layer of the first substrate layer 11 in relation to the second substrate layer 12. This prevents a displacement or shift of the first substrate layer 11 and the second substrate layer 12 occurring during the further process. A single first part area 21 or a number of first part areas 21 spatially separated from one another may be involved in this case. In one embodiment, at least two first part areas 21 spatially separated from one another may be realized between the first substrate layer 11 and the second substrate layer 12.

For example, use is made in this case of the fact that it is sufficient to harden comparatively small first part areas 21 in order to prevent a displacement and/or a shift between the first substrate layer 11 and/or the second substrate layer 12 being able to occur. The final hardening is then undertaken in the second hardening act A2, which is shown here as the fifth method act. The hardening in the final hardening act takes place here in the second part area, which may form the rest of the material bonding means layer. For example, a heating or warming is provided as the second hardening means (e.g., the introduction of thermal energy). The pre-fixed stack made up of the first substrate layer 11 and the second substrate layer 12 is arranged in an appropriate oven and subjected to warming. In one embodiment, this makes it possible to harden a second part area of the material bonding means layer and thus to provide a final bond between the first substrate layer 11 and the second substrate layer 12, whereby the body is finally provided from which the component 1 may ultimately be produced.

In one embodiment, there is provision in a sixth method act (not shown here) for the component 1 to be cut out from the body that is provided after the second hardening act A2. For example, the edge areas of the body are removed in order to remove corresponding unnecessary structures in the edge areas and to provide the desired shape of the component.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for producing a component for a medical imaging device, the method comprising:
providing a first substrate layer and a second substrate layer;
stacking the first substrate layer and the second substrate layer, wherein a material bonding layer is arranged between the first substrate layer and the second substrate layer;
material-to-material bonding of the first substrate layer to the second substrate layer though hardening;
providing the component that comprises the first substrate layer and the second substrate layer, which are bonded to one another in a material-to-material manner via the material bonding layer, which comprises a material bonding,
wherein the hardening comprises a first hardening step and a second hardening step, and
wherein a first part area of the material bonding layer is hardened in the first hardening step, and a second part area of the material bonding layer is hardened in the second hardening step.

2. The method of claim 1, wherein the component for the medical imaging device is a radiation-guidance component for the medical imaging device.

3. The method of claim 1, wherein the first substrate layer has a first cutout, and the second substrate layer has a second cutout, and
wherein the first substrate layer and the second substrate layer are stacked such that the first cutout and the second cutout are arranged in a stack direction overlapping at least in sections.

4. The method of claim 2, wherein a structuring is realized by the arrangement of the first cutout and the second cutout.

5. The method of claim 4, wherein the structuring is a micro structuring.

6. The method of claim 4, wherein the structuring has an aspect ratio that is greater than two.

7. The method of claim 6, wherein the aspect ratio that is greater than ten.

8. The method of claim 7, wherein the aspect ratio that is greater than twenty.

9. The method of claim 1, wherein the first hardening step is concluded after a first time interval, and the second hardening step is concluded after a second time interval, and
wherein the second time interval is greater than the first time interval.

10. The method of claim 1, wherein the first hardening step is brought about by a first hardening means, and the second hardening step is brought about by a second hardening means, and
wherein the first hardening means differs from the second hardening means.

11. The method of claim 10, wherein the means of material bonding is hardenable with the first hardening means and the second hardening means.

12. The method of claim 1, further comprising using a holding apparatus to simplify the stacking, to stabilize the arrangement of first substrate layer and second substrate layer, or a combination thereof at least during the first hardening step.

13. The method of claim 12, further comprising removing the holding apparatus at a time before the second hardening step from the arrangement made up of the first substrate layer and the second substrate layer.

14. The method of claim 1, wherein after the stacking, the first substrate layer and the second substrate layer are pressed against one another.

15. The method of claim 1, wherein providing the component comprising cropping a body that comprises the first substrate layer and the second substrate layer connected to the first substrate layer by material-to-material bonding, after the hardening.

16. The method of claim 1, wherein the first substrate layer, the second substrate layer, the means of material bonding, or any combination thereof is made of an x-ray-proof material.

17. The method of claim 1, wherein the material bonding layer is applied to the first substrate layer, the second substrate layer, or the first substrate layer and the second substrate layer by a transfer method.

18. The method of claim 17, wherein the material bonding layer is applied to the first substrate layer, the second substrate layer, or the first substrate layer and the second substrate layer by the transfer method at a time before the stacking of the first substrate layer, the second substrate layer, or the first substrate layer and the second substrate layer.

19. A method for production and integration of a component into a medical imaging device, the method comprising:
producing the component, the producing of the component comprising:
providing a first substrate layer and a second substrate layer;
stacking the first substrate layer and the second substrate layer, wherein a material bonding layer is arranged between the first substrate layer and the second substrate layer;
material-to-material bonding of the first substrate layer to the second substrate layer though hardening; and
providing the component that comprises the first substrate layer and the second substrate layer, which are bonded to one another in a material-to-material manner via the material bonding layer, which comprises a means of material bonding, wherein the hardening comprises a first hardening step and a second hardening step, and wherein a first part area of the material bonding layer is hardened in the first hardening step, and a second part area of the material bonding layer is hardened in the second hardening step; and
integrating the component into the medical imaging device.

20. The method of claim 19, wherein the component is arranged in the medical imaging device such that the component serves to guide radiation.
